(19) United States
(12) Patent Application Publication
(10) Pub. No.: US 2007/0210703 A1
(43) Pub. Date: Sep. 13, 2007

(54) Electroluminescent device and method for producing it

(75) Inventors: Shahrol Izzanni, Penang (MY); Silvio Grespan, Penang (MY)

Correspondence Address: COHEN PONTANI LIEBERMAN & PAVANE LLP, Suite 1210, 551 Fifth Avenue, New York, NY, 10176, US

(73) Assignee: Osram Opto Semiconductors GmbH, Regensburg (DE)

(21) Appl. No.: 11/711,579

(22) Filed: Feb. 27, 2007

Related U.S. Application Data
(60) Provisional application No. 60/777,305, filed on Feb. 28, 2006.

(51) Int. Cl. H01J 1/62

(52) U.S. Cl. 313/504; 313/512

(57) ABSTRACT

An electroluminescent device 1 comprising a functional region 5, which emits light having a first spectral distribution 7, and comprising a filter layer 10, which is arranged in the beam path 6 of the functional region 5 and absorbs spectral subranges of the light of the first spectral distribution, with the result that light having a second spectral distribution is emitted by the device 1.

### RELATED APPLICATION

This application claims priority from U.S. Provisional Patent Application Ser. No. 60/777,305 filed on Feb. 28, 2006. The content of which is hereby incorporated herein by reference.

### FIELD OF THE INVENTION

The present invention relates to an electroluminescent device in which a simple setting of the light which is emitted by the device and perceived by the observer is possible.

### SUMMARY OF THE INVENTION

One embodiment of the invention specifies an electroluminescent device which has a functional region, which emits light having a first spectral distribution, and additionally has a filter layer, which is arranged in the beam path of the functional region and absorbs spectral subranges of the light of the first spectral distribution, with the result that light having a second spectral distribution is emitted by the device.

This light can then be perceived by an observer outside the device as actual light emitted by the device in the region of the filter layer.

In this case, the filter layer may have transmission properties which permit parts of the light of the first spectral distribution to be absorbed or reflected, so that the light having the resulting second spectral distribution has a correspondingly reduced spectral distribution (see, for example, FIGS. 6A to 6C). The filter layer may be present for example in the form of a film, so that the latter can be arranged particularly simply by means of lamination, for example, in the beam path of the functional region. However, the filter layer can also be produced by means of e.g. printing methods on different regions of the device.

In this case, the functional region advantageously has a first electrode layer, an organic functional layer arranged on the first electrode layer, and a second electrode layer on the at least one organic functional layer. The organic functional layers may be the organic electroluminescent materials mentioned further below. If a voltage is applied to the first and second electrode layers, electrons and “holes” are injected into the at least one organic functional layer, emission of light occurring upon a recombination of the electrons and “holes” (electroluminescence).

The functional region advantageously emits light of one color. This can be realized for example by only a single light-emitting functional layer being present within the functional region, which layer comprises only a single light-emitting material. Said light-emitting material may be for example an organic functional layer, for example on the basis of polymers such as poly(p-phenylenevinylene) (PPV) or on the basis of so-called low-molecular-weight small molecules such as e.g. tris(8-hydroxyquinolinato)aluminum (Alq). The polymeric organic compounds can be applied on any desired substrate for example by means of wet-chemical methods, for example ink jet printing, spin coating or blade coating. Apart from this, the so-called “small molecules” can also be applied to any desired substrate by means of vapor deposition. These devices are also referred to as organic light emitting diodes (OLEDs).

It is furthermore advantageous if the first electrode layer is structured into first electrode strips running parallel to one another and the second electrode layer is structured into second electrode strips running parallel to one another, wherein the first and second electrode strips run transversely, advantageously perpendicularly, with respect to one another.

With such an arrangement of first and second electrode strips, a passive matrix arrangement can be realized in a particularly simple manner, wherein, at the crossover points of the first and second electrode strips, active luminous regions, for example pixels, are formed which can be driven selectively by means of the application of a voltage to the first and second electrode strips. A passive matrix arrangement of this type is particularly advantageous for an electroluminescent display, for example an organic electroluminescent display, which can be used for representing information and, for example, graphical elements and/or information, such as numbers or letter. However, it is also possible to realize an active matrix arrangement in the case of electroluminescent devices according to some embodiments of the invention, in which case said active matrix arrangements then also comprise pixels.

The pixels of both the passive and the active matrix arrangements can advantageously be driven separately (e.g. the above-mentioned crossover points of electrode strips running perpendicularly to one another). The pixels may furthermore comprise active electroluminescent regions that are separate from one another, or else be constituent parts of a single contiguous electroluminescent layer.

The functional region can particularly advantageously emit white light. For this purpose, it is possible to use e.g. mixtures of different electroluminescent materials, in which case white then results on account of color mixing of the different colors emitted by the materials, or it is also possible to use only a single material which inherently emits white light. By way of example, the material C-EXP-W001, which is commercially available from MOM (Merck OLED Materials GmbH), can be used. A white light emitting functional region, or a white light emitting organic functional layer within an organic electroluminescent device has the advantage that by means of corresponding arrangement of the filter layer and configuration of said filter layer into different partial regions which in each case absorb different spectral ranges of the light, an electroluminescent device which emits a wide variety of colors and therefore represents a multicolor or full color device can be obtained in a particularly simple manner. In this case, a device of this type can be achieved in a particularly simple manner by producing a single light emitting, for example organic, layer region on the complete surface of a substrate, in which case a device which emits any desired colors and may also be full color depending on the configuration of the filter layer can then be obtained in a particularly simple manner by variation of the filter layer, for example its division into different partial structures that absorb different spectral subranges of the light. Consequently, in the case of electroluminescent devices of the invention, given the same electroluminescent materials, devices which emit light of different wavelengths that is perceived by the observer can be obtained solely by variation of the filter layer.

In a further embodiment of the invention, the filter layer comprises partial regions which in each case have different light-absorbing or -reflecting filter materials. In this case, a partial region of the filter layer can advantageously be assigned not only to one pixel, but to at least two, more preferably a plurality of pixels.

The filter layer may expediently comprise organic dies which can be processed particularly easily and are e.g. already used in the LCD (liquid crystal display) industry.

In a further embodiment of the invention, the filter layer comprises a film arrangement containing an adhesive layer, a plastic layer on the adhesive layer, and a color filter layer on the plastic layer.

A film arrangement of this type can be fixedly connected to the electroluminescent device in a particularly simple manner, for example via the adhesive layer. In this case, the plastic layer serves as a type of carrier layer between the adhesive layer and the color filter layer and preferably comprises plastics having a high transmission, for example polyester, polycarbonate or polyethylene. A wide variety of transparent materials, e.g. epoxy or the like, can be used for the adhesive layer.

In other embodiments of the invention, the film arrangement may also be constructed such that the color filter layer is arranged on the plastic layer, the adhesive layer then being situated on said color filter layer. In this embodiment, too, the film arrangement is connected to the electroluminescent device via the adhesive layer.

In this case, the plastic layer may also be birefringent.

In another embodiment of the invention, an encapsulation is present over the functional region and the functional region is arranged on a substrate. In this case, the filter layer may then be arranged on that area of the substrate and/or of the encapsulation which is remote from the functional region.

In an embodiment of this type, the filter layer can be arranged in a particularly simple manner on the outer areas of the substrate and/or of the encapsulation. In this case, a variation of the light which is emitted by the electroluminescent device and is perceived by the observer can be achieved solely by variation of the filter layer while maintaining one and the same functional region. By means of different geometrical configurations of differently absorbing partial regions of the filter layer, as shown in FIG. 5, for example, many different electroluminescent devices can therefore be realized solely by variation of the filter layer. In the case of a white light emitting functional region, by means of varying arrangement of the filter layer with differently absorbing partial regions, it is possible to realize, in a particularly simple manner, different geometrical arrangements and hence different emission characteristics of the electroluminescent device in a manner dependent on the filter layer.

It is furthermore advantageous if the filter layer comprises a light-absorbing ink to be applied by means of an ink printing method. The ink printing method is a particularly simple printing method in which it is also possible to apply at the same time structured filter layers particularly easily to the substrate or the encapsulation, by way of example.

Furthermore, a circular polarizer may additionally be arranged in the beam path of the device in further embodiments of the invention. The circular polarizer may preferably be shaped in layered fashion and be present e.g. as a film.

A circular polarizer of this type is particularly good at preventing back-reflection of the light which enters the device externally, and therefore also increases the contrast of the device in bright surroundings.

The circular polarizer is particularly advantageous when an electrode layer is light-reflecting and is formed for example in mirroring fashion. In this case, by way of example, the electroluminescent device can serve as a mirror in the switched-off state, while in the switched-on state it serves for illumination or displays graphical elements or information.

In the case where a variant of an electroluminescent device according to the invention has both a filter layer and a circular polarizer, different possibilities for the arrangement of the circular polarizer relative to the filter layer are possible in a particularly advantageous manner:

In the case where the filter layer comprises one of the film arrangements mentioned above and the plastic layer present in the film arrangement simultaneously comprises a highly birefringent material, for example polycarbonate or polyester, the film arrangement of the filter layer is particularly advantageously arranged downstream of the circular polarizer in the beam path of the device. This means that the circular polarizer is arranged nearer to the functional region than the film arrangement of the filter layer in the beam path. It is further preferred for the filter layer to be arranged on the circular polarizer, which is in turn situated on the substrate and/or the encapsulation of the electroluminescent device. A high contrast and a dark background can thereby be ensured in a particularly simple manner.

It is furthermore possible for the plastic layer of the film arrangement of the filter layer to contain a material which is not birefringent or has only low birefringent properties, so that the function of the circular polarizer is not disturbed or is only slightly disturbed. In this case, the filter layer may be disposed upstream of the circular polarizer in the beam path of the device. This can be realized for example by arranging the circular polarizer on the filter layer, the filter layer being positioned nearer to the functional light emitting region than the circular polarizer. An arrangement of this type is particularly suitable for concealing the light scattering of the filter layer or of the individual color filter regions of the filter layer under the circular polarizer, so that the different colors of the filter layer are not visible or visible only to a limited extent in the switched-off state of the device.

It is furthermore possible for the filter layer to comprise none of the film arrangements mentioned above, but rather to be produced for example by means of a printing method, for example ink jet printing, or pad printing. In this case, the filter layer can be produced in a particularly simple manner, for example by means of the printing methods mentioned above, on an existing encapsulation and/or an existing substrate on which the functional region is arranged. In this case, too, the filter layer may be disposed either upstream or downstream of the circular polarizer in the beam path of the device, depending on the application.

In the cases in which the circular polarizer is arranged on the filter layer, it is particularly advantageous if a planarization layer is present between the circular polarizer and the filter layer (see FIG. 4, for example).

A planarization layer of this type can in this case compensate in a particularly simple manner for the unevennesses of the filter layer, for example the unevennesses of the individual partial regions of the filter layer with different filter materials, for example, with the result that the circular polarizer can then be arranged particularly well on the planarization layer, for example by means of adhesive bonding or lamination. Examples of appropriate materials for the planarization layer are epoxy or similar transparent material.

In a further embodiment of the invention, at least partial regions of the filter layer may be structured to form graphical elements. Said graphical elements can then be displayed during the operation of the device. By varying this graphical configuration, it is thus possible, given the same functional regions, to realize electroluminescent devices which display different graphical elements on the basis of the variation of the filter layer.

The invention furthermore relates to various embodiments of a method for producing the electroluminescent device. In one embodiment, the method comprises the following method steps:

A) The functional region is provided,

B) the filter layer is produced in the beam path of the functional region.

In a particularly advantageous manner, in method step A), the functional region is produced on a substrate and then an encapsulation is applied over the functional region of the substrate. In this case, in method step B), the filter layer can then be produced on that area of the substrate and/or of the encapsulation which is remote from the functional region.

Furthermore, in one embodiment of a method according to the invention, in a further method step C), a circular polarizer may be produced on that area of the substrate and/or of the encapsulation which is remote from the functional region. As already mentioned above, the circular polarizer may be disposed upstream or arranged downstream of the filter layer in the beam path, as required.

In this case, the filter layer may be produced in the form of the film arrangement—already mentioned above—for example on the substrate or the encapsulation, in which case this may be effected by means of lamination or adhesive bonding, by way of example. Furthermore, the filter layer may also be produced e.g. by means of various printing methods on the substrate and/or the encapsulation.

Electroluminescent devices in accordance with the various embodiments of the invention can be used for illumination purposes, by way of example. It is also possible, however, to use the devices as displays for representing graphical elements and/or information, for example numbers or letters.

By way of example, it is possible to use the abovementioned passive matrix arrangement or the active matrix arrangements with first and second electrode strips running transversely or perpendicularly to one another in an illumination device, too. In this case, the crossover points of the respective first and second electrode strips serve as active illumination points which can be used in each case separately or together with all the other illumination points for illuminating rooms, by way of example.

### BRIEF DESCRIPTION OF THE DRAWINGS

The invention is explained in even more detail below on the basis of exemplary embodiments and figures. In this case, the figures are schematic and not true to scale.

FIG. 1 shows one embodiment of an electroluminescent device according to the invention.

FIG. 2 shows a further embodiment of an electroluminescent device according to the invention.

FIG. 3 shows a film arrangement as an example of a filter layer.

FIG. 4 shows an arrangement of a circular polarizer on a filter layer, a planarization layer being present.

FIG. 5 shows a further configuration of a filter layer having different light-absorbing partial regions.

FIGS. 6A to 6C illustrate the functional principle of the filter layer.

FIG. 7 shows a pad printing machine for producing a filter layer on an electroluminescent device.

### DETAILED DESCRIPTION OF THE DRAWINGS

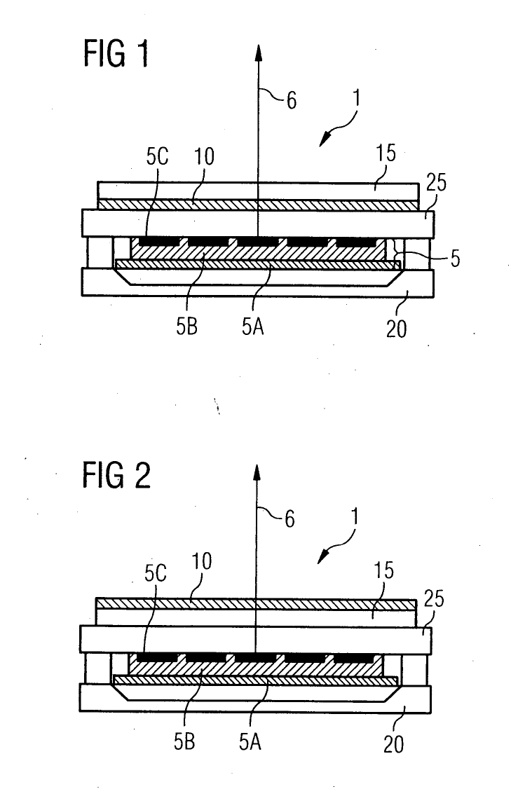

FIG. 1 shows an organic electroluminescent device 1, in which the functional region 5 has first electrode strips 5A and second electrode strips 5C running perpendicularly thereto, at least one functional organic layer 5B being arranged in between, said functional organic layer comprising three layers in this case. Said three layers may be, for example, hole-transporting layers, electron-transporting layers and a light-emitting layer arranged in between. However, e.g. any other layer arrangement such as a PEDOT (polyethylenedioxythiophene)-PPV two-layer arrangement are also possible. The functional region 5 is arranged on a substrate 20, which is encapsulated by means of an encapsulation 25 with respect to ambient influences, for example oxidizing permeants and water. In this case, the first electrode strips 5A may be embodied in light reflecting or mirroring fashion, with the result that the principal beam path 6 of the electroluminescent device 1 runs through the encapsulation 25. A color filter layer 10 and a circular polarizer 15 are arranged on the outer surface of the encapsulation 25. In this case, the filter layer 10 is disposed upstream of the circular polarizer 15 in the beam path 6 of the electroluminescent device 1, the circular polarizer being arranged on the filter layer. However, electroluminescent devices according to the invention are also possible in which the generated light is coupled out through the transparent substrate 20 and then the circular polarizer and the filter layer are correspondingly arranged on the outer surface of the substrate.

FIG. 2 shows the same organic electroluminescent device 1 as illustrated in FIG. 1, wherein, in contrast to FIG. 1, the order of the filter layer 10 and the circular polarizer 15 has been interchanged, with the result that the filter layer 10 is disposed downstream of the circular polarizer 15 in the beam path 6 of the electroluminescent device 1 in this case.

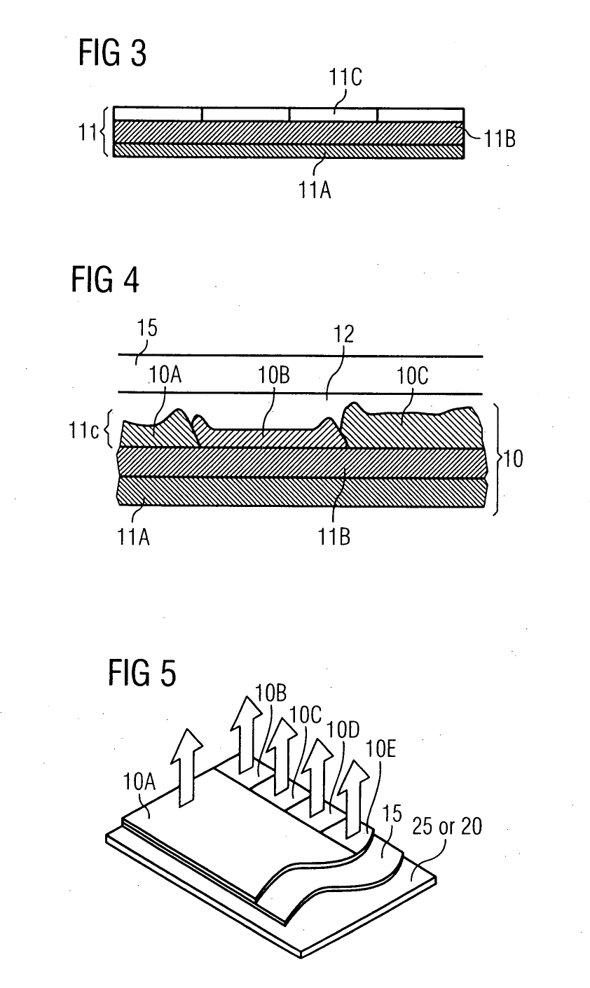

FIG. 3 shows in detail a simplified illustration of a film arrangement 11 of a filter layer 10. It can be discerned here that an adhesive layer 11A is present, on which a plastic layer 11B is arranged. Situated on the plastic layer 11B is a color filter layer 11C, which is either made in its entirety of a material having a particular chemical composition or it has different partial filter regions with different chemical compositions that in each case absorb light of different wavelengths. As already mentioned above, the adhesive layer 11A may serve in a particularly simple manner for fixing the film arrangement 11 on an electroluminescent device according to the invention.

FIG. 4 shows an arrangement comprising a filter layer 10, a planarization layer 12 arranged thereon, and a circular polarizer 15 on the planarization layer 12. This is a portion of the complete layer arrangement. A planarization layer 12 is particularly well suited to planarizing the unevennesses of the partial regions 10A, 10B and 10C of the color filter layer 11C that are illustrated here for example when the circular polarizer 15 is arranged on the filter layer 10, as is shown in FIG. 1, by way of example. In this case the filter layer 10 again additionally comprises an adhesive layer 11A and plastic layer 11B.

FIG. 5 shows a particular configuration of the filter layer 10, in which here at least five different partial regions 10A to 10E are present which have different light-absorbing filter materials and thus lead to the emission of light of different wavelengths. In this case, the filter layer 10 is arranged on the circular polarizer 15, which is in turn situated on the substrate 20 or the encapsulation 25.

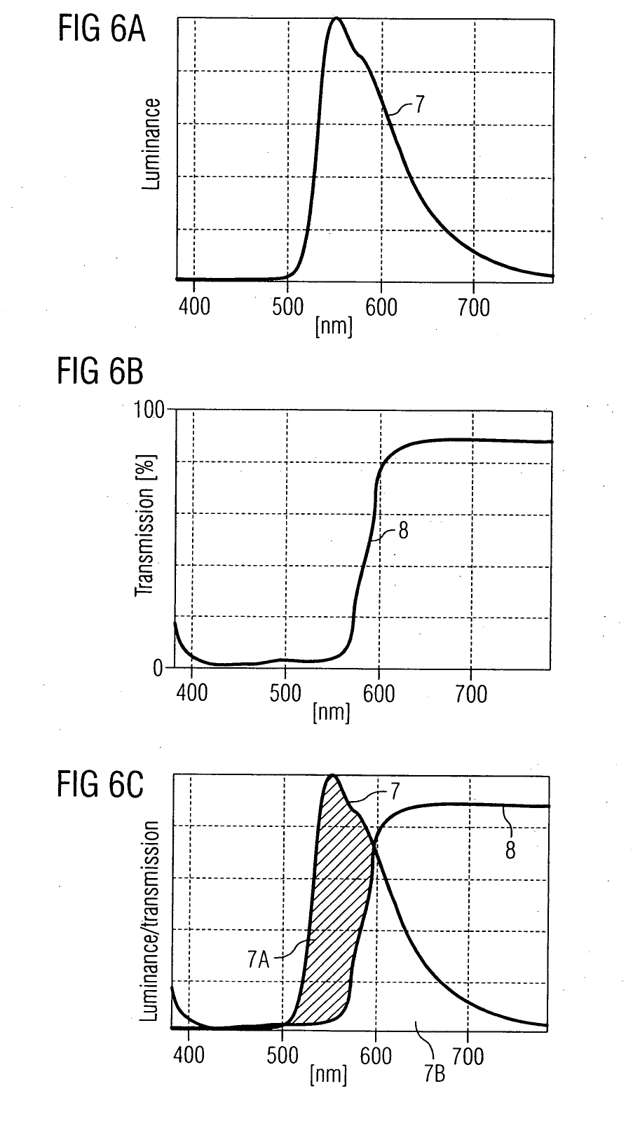

FIG. 6A shows, in a diagram in which the luminance is plotted against the wavelength, the first spectral distribution 7 of the light emitted by a functional region 5 of an electroluminescent device 1 of the invention. In this case, a light that appears yellow to the observer on account of the spectral distribution is emitted here.

FIG. 6B shows the profile of a transmission 8 of a filter layer 10 or of a partial region 10A, 10B or 10C of a filter layer 10 as a function of the wavelength. It can be discerned here that the filter has a very low transmission in the range between approximately 400 nm and 580 nm and therefore either absorbs or reflects most of the light in this wavelength range. A very high transmission is achieved in a wavelength range of from approximately 600 nm to above 800 nm, with the result that the majority of the light can pass through the filter layer.

FIG. 6C shows, in a simplified graphical illustration, how the filter layer 10 from FIG. 6B interacts with the light emitted by functional region 5 in accordance with FIG. 6A. It can be discerned here that, on account of the transmission properties 8 of the filter layer, the first spectral distribution 7 of the light emitted by the functional region produces a light having the second spectral distribution 7B on account of the absorption or reflection of the absorbed subranges 7A (hatched area) in the filter layer. On account of this arrangement, for example in the case of a yellow emitting light and the red-orange filter present here, a deep orange light is coupled out from the electroluminescent device and perceived by the observer. It is also possible to combine any other combinations of light emitted by the functional region with differently absorbing filter layers, with the result that light of any desired color can be obtained. In order to obtain the spectrum of the light emitted by the electroluminescent device and perceived by an observer, the spectrum of the light emitted by the functional region is multiplied by the transmission of the filter layer.

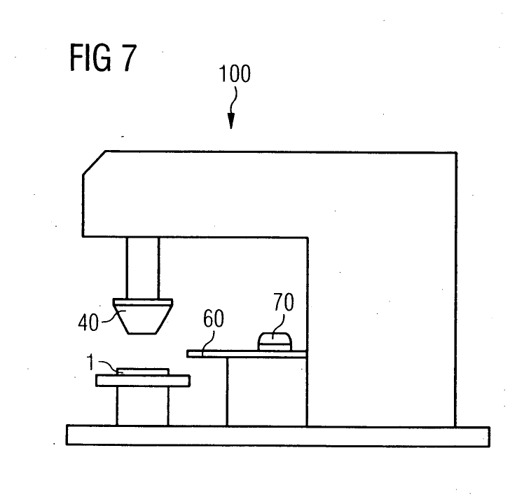

FIG. 7 shows a schematic illustration of a pad printing machine 100, which is suitable for producing a color layer as the filter layer on an electroluminescent device 1. Such machines are well known, and one that is preferred for use with an embodiment of the present invention is made by COMEC ITALIA as model no. XE13A. In this case, a pad is designated by 40 and a printing plate is designated by 60. The ink cup 70 stores the ink and it can be moved forward and backward to dispense the ink. The electroluminescent device 1 is placed on a table with a vacuum system to keep the device in position.

On the basis of the printing method and also by variation of the thickness of the applied ink absorption layer as the filter layer and the concentration of the absorbent dies, it is possible, in a particularly advantageous manner, to achieve a fine tuning of the emitted light radiation ultimately perceived by the observer from electroluminescent devices according to the invention. A pad printing machine, particularly in interaction with an optical positioning and orienting system, can ensure that the filter layer is produced particularly precisely. In this case, the pad printing machine comprises an individual printing plate or a plurality of printing plates in which the design or the structure of the filter layer has been etched. Furthermore, individual or a plurality of pads are present for transferring the light-absorbing ink to the substrate or the encapsulation of the electroluminescent device. For standard methods, a 64 wire/cm printing plate is sufficient to ensure a uniform application of the ink on the electroluminescent device. A printing plate having a plurality of wires can be used for special designs with a small region to be printed.

The thickness of the ink layer influences the final color saturation and the light transmission of the filter layer.

A relatively small thickness of the ink leads to a less saturated color of the emitted light ultimately perceived by the observer and a high light transmission, while a relatively large thickness of the ink layer gives the observer a saturated color impression in conjunction with lower light transmission.

The thickness of the layer of ink may primarily be influenced by the etching depth of the printing plate and the type of pad. An etching depth of 20 μm leads, in the case of a printing plate, to a uniform coverage which simultaneously represents a good compromise between a good transmission and saturation of the colors perceived by the observer. Depending on the intended application, it is possible to use two different ink materials. UV-curable inks can be used in applications in a standard temperature range and with low mechanical stress. Two-component inks can be used in a wider temperature range to be used with high mechanical stress, since they have a higher adhesion to the glass of the substrate and/or the encapsulation.

The invention illustrated here is not restricted to the exemplary embodiments shown here. Further exemplary embodiments are possible for example on the basis of different geometrical shapings of the filter layer.

The scope of protection of the invention is not limited to the examples given hereinabove. The invention is embodied in each novel characteristic and each combination of characteristics, which includes every combination of any features which are stated in the claims, even if this feature or combination of features is not explicitly stated in the examples.

We claim:

1. An electroluminescent device comprising:
a functional region, which emits light having a first spectral distribution, and
a filter layer, which is arranged in the beam path of the functional region and is adapted to absorb spectral subranges of the light of the first spectral distribution, with the result that light having a second spectral distribution is emitted by the device.

2. The device as claimed in claim 1, in which the functional region can emit white light.

3. The device as claimed claim 1, wherein the functional region comprises:
a first electrode layer,
at least one organic functional layer arranged on the first electrode layer, and
a second electrode layer on the at least one organic functional layer.

4. The device as claimed in claim 3, in which the first electrode layer comprises first electrode strips running parallel to one another and the second electrode layer comprises second electrode strips running parallel to one another, wherein the first and second electrode strips run transversely with respect to one another.

5. The device as claimed in claim 1, in which the filter layer comprises different partial regions which in each case absorb different spectral ranges of the light of the first spectral distribution.

6. The device as claimed in claim 1, in which the filter layer comprises organic dies.

7. The device as claimed in claim 1, in which the filter layer has a film arrangement comprising an adhesive layer, a plastic layer on the adhesive layer and a color filter layer on the plastic layer.

8. The device as claimed in claim 7, in which the plastic layer comprises a polymer selected from: polyester, polycarbonate and polyethylene.

9. The device as claimed in claim 7, in which the plastic layer is birefringent.

10. The device as claimed in claim 1, in which an encapsulation is present over the functional region and the functional region is arranged on a substrate, wherein the filter layer is arranged on that area of the substrate and/or of the encapsulation which is remote from the functional region.

11. The device as claimed in claim 1, in which the filter layer comprises a light-absorbing ink applied by means of an ink printing method.

12. The device as claimed in claim 1, in which a circular polarizer is additionally arranged in the beam path of the device.

13. The device as claimed in claim 12, in which the circular polarizer is arranged on the filter layer, wherein a planarization layer is present between the circular polarizer and the filter layer.

14. The device as claimed in claim 12, in which the filter layer comprises a birefringent plastic layer, and
in which the filter layer is arranged downstream of the circular polarizer in the beam path of the device.

15. The device as claimed in claim 12, in which one of the electrode layers is light-reflecting.

16. The device as claimed in claim 1, in which at least partial regions of the filter layer are structured to form graphical elements.

17. The device as claimed in claim 1, in which the filter layer comprises different partial regions,
in which the functional region comprises a multiplicity of pixels,
wherein a partial region of the filter layer is assigned to at least two pixels.

18. A method for producing an electroluminescent device as claimed in claim 1, comprising the following method steps:
A) providing the functional region, and
B) producing the filter layer in the beam path of the functional region.

19. The method as claimed in claim 18, in which, in method step B), the filter layer is produced by means of a printing method.

20. The method as claimed in claim 18, in which, in method step B), the filter layer is produced by application of a film arrangement in which the filter layer has a film arrangement comprising an adhesive layer, a plastic layer on the adhesive layer and a color filter layer on the plastic layer.

21. The method as claimed in claim 20, in which, in method step B), the film arrangement is applied by means of lamination.

22. The method as claimed in claim 18, wherein, in a method step C), a circular polarizer is produced in the beam path of the device.

23. The method as claimed in claim 22, wherein a planarization layer is produced on the filter layer and then the circular polarizer is produced on the planarization layer.

24. The method as claimed in claim 22, in which the circular polarizer is produced first and then the filter layer is produced on said polarizer.

25. The method as claimed in claim 19, in which, in method step A), the functional region s produced on a substrate and an encapsulation is fitted over the functional region on the substrate, wherein, in method step B), the filter layer is produced on that area of the substrate and/or of the encapsulation which is remote from the functional region.

26. The method as claimed in claim 25, in which, in method step C), a circular polarizer is produced on that area of the substrate and/or of the encapsulation which is remote from the functional region.

27. The use of a device as claimed in claim 1 for illumination.

28. The use of a device as claimed in claim 1, as a display for representing graphical elements and/or information.
